(19) United States
(12) Patent Application Publication
(10) Pub. No.: US 2005/0097407 A1
(43) Pub. Date: May 5, 2005

(54) System and method for management of remote software deployment to information handling systems

(76) Inventors: Weijia Zhang, Round Rock, TX (US); Daniel Bertram, Cedar Park, TX (US); Ruoting Huang, Round Rock, TX (US); Yiqing Lai, Round Rock, TX (US); Richard B. Landau, Austin, TX (US); Jorge L. Pando, Round Rock, TX (US); Hai Phung, Austin, TX (US); Anusha Ragunathan, Austin, TX (US)

Correspondence Address: Robert W. Holland;Attorney for Applicant(s), HAMILTON & TERRILE, LLP, PO Box 203518, Austin, TX, 78720, US

(21) Appl. No.: 10/700,882

(22) Filed: Nov. 4, 2003

(51) Int. Cl. G06F 11/00

(52) U.S. Cl. 714/100

(57) ABSTRACT

A remote deployment manager infers a target information handling system state from status information discovered from the target information handling system and applies the inferred target information handling system state to validate actions performed to the target information handling system. A discovery module discovers status information to which an inferred state engine applies state calculation rules to infer a target state without having to rely on tasks performed to the target. An action. validator applies the inferred state to actions requested from a user interface to ensure that only valid actions are communicated to a target information handling system. Valid actions may include remote commands for RAID configuration, capture of an image, deployment of a captured image or preassignment of an image to an undiscovered target information handing system.

### BACKGROUND OF THE INVENTION

1. Field of the Invention

The present invention relates in general to the field of information handling system manufacture, and more particularly to a system and method for management of remote software deployment to information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Manufacturing information handling systems to fulfill the diverse tasks demanded by consumers often presents a complex task of building systems with selected components and applications. When information handling systems are built to order, each system that passes through the manufacturing process has uniquely ordered hardware and software components so that a large number of potential configurations may result. Generally, in order to make the process of deploying and configuring software less time consuming, information handling system manufacturers use a variety of commercial applications that copy images of desired software to manufactured information handling systems. As systems are built, the systems are interfaced with software deployment servers that copy operating systems and applications to the hard disc drives of the manufactured systems. For instance, various commercially available applications provide images to manufactured information handling systems and aid in the management of deployment of software to target information handling systems. After manufacture and distribution of information handling systems, users often deploy similarly configured information handling systems in order to reduce the complexity of integrating systems to a network and servicing the information handling systems. In such networks, information technology administrators sometimes use software deployment applications to deploy new software to networked information handling systems and to re-deploy existing configurations to maintain information handling systems on the network.

One difficulty that arises with information handling system manufacture and software deployment is the remote management of the deployment process to monitor manufacturing status and quality control. Effective management of software deployment and configuration generally requires knowledge of the state of target information handling systems provide to a location remote from the target systems and manufacturing floor. Accurate information as to the state of a target information handling system helps software deployment personnel ensure that deployment tasks are accomplished accurately and that valid deployment tasks are performed on desired target information handling systems. In particular, accurate state information is called for where software deployment involves more complex actions than just copying an image to a hard disc drive. For instance, software deployment managers sometimes adjust the deployment process to perform RAID configuration, capture of an image of a manufactured target information handling system, deployment of a captured image to other target information handling systems and configuration of deployed software. However, conventional software deployment tools typically determine target information handling system state information with a task oriented or dynamic provisioning approach. The task oriented approach determines target status by monitoring the execution of assigned tasks at a target. Dynamic provisioning determines target status through analysis of a server system separated into hardware server assets and software assets.

### SUMMARY OF THE INVENTION

Therefore a need has arisen for a system and method which manages software deployment and configuration by remotely inferring a target information handling system state from status information discovered from the target information handling systems.

In accordance with the present invention, a method and system are provided which substantially reduce the disadvantages and problems associated with previous methods and systems for managing software deployment and configuration to manufactured information handling systems. A remote deployment manager infers a target information handling system state from status information remotely discovered from the target system and applies inferred target system states to manage valid actions at the target systems by remote deployment systems.

More specifically, a discovery module of a remote deployment manager remotely discovers status information from target information handling systems through remote deployment systems that deploy software to the target systems. A rules-based inferred state engine applies state calculation rules and a target state table to infer a state for the target information handling system from the discovered status information. The remote deployment manager validates actions received for target information handling systems with an action validator that applies inferred states and requested actions to rules for action and prevents communication of invalid actions to target information handling systems. In one embodiment, a capture module captures images from selected target information handling systems for subsequent deployment to manufactured information handling systems. A preassignment module preassigns a captured configuration to selected target information handling systems to have deployment of the captured image to the selected targets when subsequently discovered by the discovery module. In another embodiment, RAID configuration is supported by an inferred state determined from status information of a local operating system loaded on a target without a request for a boot to the local operating system.

The present invention provides a number of important technical advantages. One example of an important technical advantage is that remote deployment and configuration of software is managed with inferred target states to allow a central management with actual status of a target instead of a comparison of pending tasks for a target. Inferred states support operations that span deployment operations including RAID configuration, image capture, deployment and configuration with processes including operating system deployment, system and network configuration and post operating system scripting, meaning scripting done after the basic operating system is deployed to the target system and configured. For instance, the remote deployment manager allows configuration of a system with a local operating system running so that a manager can install agents on the target and configure the system to an “up” state for production use. Further, deployment is supported to systems that do not have a local operating system image installed (“bare metal” systems), systems with operating systems installed and systems designated for RAID before image deployment.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for management of remote deployment of software to information handling systems; and

FIG. 2 depicts a flow diagram of a example of a process for inferring information handling system deployment states.

### DETAILED DESCRIPTION

Deployment of software to information handling systems is managed with inferred states of deployment targets to allow remote performance of deployment tasks consistent with an inferred state. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

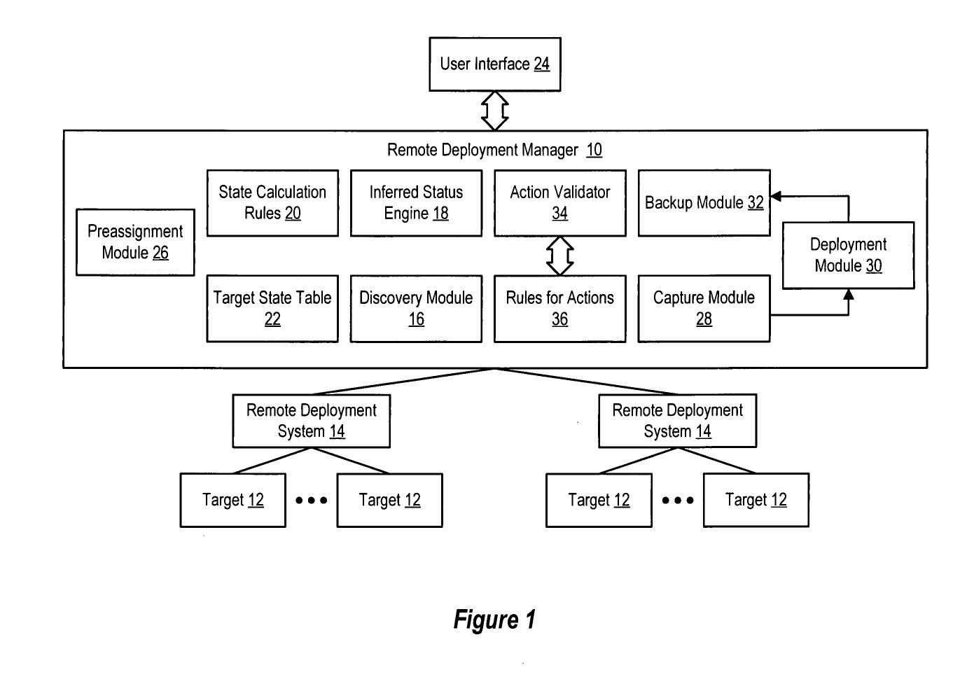

Referring now to FIG. 1, a block diagram depicts a remote deployment manager 10 that manages deployment of software to manufactured target information handling systems 12 through remote deployment systems 14 by inferring the states of target systems 12. A discovery module 16 obtains status information from a target 12 and the target's remote deployment system 14, such as the identity of hardware and software operational on target 12, and provides the discovered status information to an inferred state engine 18. Inferred state engine 18 infers a target state by applying state calculation rules 20 against a target state table 22 that associates discovered state information to defined states. The inferred state is available for display at user interface 24 and for application to software deployment functions. A user at interface 24 is provided with accurate information about the state of any monitored target by checking target state instead of relying on a description of pending or accomplished deployment tasks. For instance, inferred states aid in software deployment work flow for RAID configuration, operating system deployment, system and network configuration, post-operating system scripting and image capture for use in subsequent deployment and configuration to manufactured information handling systems. Automatic discovery of inferred states enables management from “bare metal” systems, through the use of deployment agents and the capture for re-deployment of configured systems.

One example of a software deployment function supported from inferred states is the preassignment of an image and configuration to a target system. Preassignment module 26 preassigns an image and a configuration to a target 12 and pushes the image and configuration to the target at reboot. In one embodiment, targets 12 are preassigned images and configurations before discovery of a target by discovery module 16, such as through association with a unique identifier, with preassignment module 26 creating a virtual system associated with an image and configuration that is automatically pushed to the target on discovery of the target. A capture module 28 allows capture of an image of a selected target 12 for use with subsequently manufactured information handling systems identified by preassignment module 26. Deployment module 30 simultaneously deploys a captured image to multiple targets 12 and backup module 32 saves a copy of a captured image for subsequent use.

The improved production flexibility provided by the inferred states of remote deployment manager 10 includes allowing configuration of RAID for an information handling system before image deployment, allowing deployment of an image to a “bare metal” system or a system that has an operating system installed, and configuring a target that has a running local operating system by installing an agent so that the image of the target may be used for subsequent production. In order to prevent a user from performing invalid actions that could disrupt manufacturing operations, an action validator 34 monitors inputs at user interface 24 and target inferred states to detect violations of rules in rules for action table 36. If an action requested at user interface 24 violates a rule for a target 12 based on the inferred state of the target, the action is refused and the user interface 24 displays the rule violation.

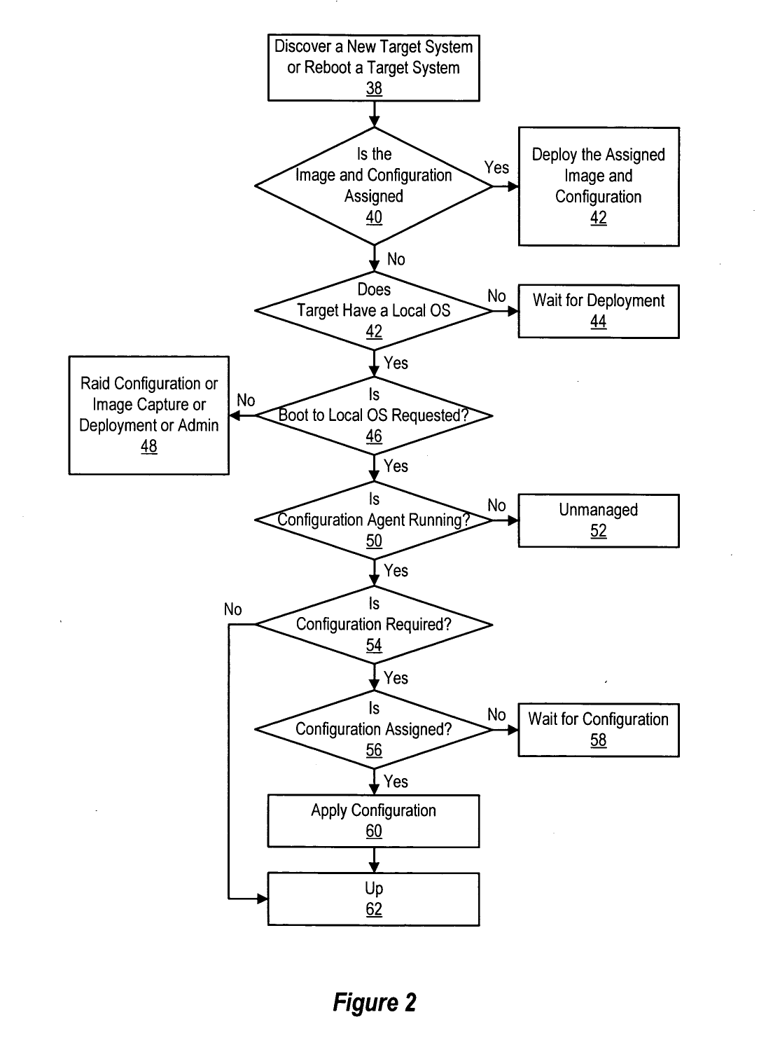

Referring now to FIG. 2, a flow diagram depicts a process applied by inferred state engine 18 to determine an inferred state of a target information handling system 12 as depicted in FIG. 1 from status information. Based on the discovery of the deployed software to a target, remote deployment manager 10 infers a state of the target in the deployment process. The process begins at step 38 with discovery of a new target information handling system or reboot of an already-interfaced target. At step 40, a determination is made of whether an image and configuration are already assigned to the target. If yes, the process continues to step 42 for deployment of the assigned image and configuration. If the image and configuration not assigned, then the process continues to step 42 for a determination of whether the target has a local operating system. If no local operating system is discovered, the process continues to step 44 to wait in a stable system state for deployment of the local operating system. If the target has a local operating system, the process continues to step 46 to determine whether a boot to the local operating system is requested. If no boot to the local operating system is requested, then at step 48, a state is inferred to be entry into RAID configuration, image capture, deployment to the target or administrative functions to the target.

If a local operating system boot is requested at step 46, the process continues to step 50 to determine if a configuration agent is running on the target. If no configuration agent is running, then at step 52 the target is determined to be in a stable unmanaged system state, such as set for a manual configuration. If a configuration agent is running, the process continues to step 54 to determine if a configuration is required for the target. If no configuration is required, the process continues to step 62 in which the target is in an “up” state in which the target is running and managed. If configuration is required at step 54, the process continues to step 56 to determine whether a configuration is assigned. If no configuration is assigned at step 56, the process continues to step 58 to wait for a configuration assignment is a stable configuration wait state. If a configuration is assigned at step 56, the process continues to step 60 for application of the configuration to the target and completes at step 62 in the “up” state.

Although the present invention has been described in detail, it should be understood that various changes, substitutions and alterations can be made hereto without departing from the spirit and scope of the invention as defined by the appended claims.

1. A system for managing remote deployment of software to target information handling systems, the system comprising:
a discovery module operable to obtain status information from the target information handling systems; and
an inferred state engine operable to analyze the discovered status information to infer a deployment state of an information handling system.

2. The system of claim 1 further comprising an action validator interfaced with the inferred state engine, the action validator operable to validate or invalidate deployment actions associated with a target information handling system based on the inferred state of the target information handling system.

3. The system of claim 2 wherein the status information comprises a local operating system loaded on a target information handling system without booting the installed local operating system and the inferred state comprises a RAID configuration.

4. The system of claim 2 wherein the status information comprises a local operating system loaded on a target information handling system without booting the installed local operating system and the inferred state comprises image capture, the system further comprising:
a capture module operable to capture an image from the target information handling system; and
a deployment module operable to deploy the captured image to selected target information handling systems.

5. The system of claim 4 further comprising a preassignment module interfaced with the deployment module and the discovery module, the preassignment module operable to coordinate deployment of a captured image to an undiscovered target information handling system after subsequent discovery of the target information handling system by the discovery module.

6. The system of claim 1 wherein the target information handling system status information comprises a local operating system running without a configuration agent and the inferred state comprises an unmanaged target information handling system.

7. The system of claim 1 wherein the target information handling system status information comprises a local operating system and configuration agent without an assigned configuration and the inferred state comprises a stable state waiting for configuration assignment.

8. The system of claim 1 wherein the target information handling system status information comprises an image and configuration assigned and the inferred state comprises deployment of the image and configuration to the target information handling system.

9. The system of claim 1 further comprising plural remote deployment systems interfaced with the discovery module, each remote deployment system operable to deploy software to plural target information handling systems.

10. A method for managing remote deployment of software to target information handling systems, the method comprising:
discovering status information from a remote target information handling system;
applying the status information to state calculation rules to infer a state of the target information handling system;
validating a deployment action associated with the target information handling system based the inferred state; and
performing the validated action at the target information handling system.

11. The method of claim 10 wherein discovering status information comprises discovering an assigned image and configuration associated with the target information handling system and the inferred state comprises deployment of the assigned image and configuration to the target information handling system.

12. The method of claim 10 wherein discovering status information comprises discovering no assigned image and configuration and no local operating system associated with the target information handling system and the inferred state comprises a stable wait state to wait for deployment of a local operating system.

13. The method of claim 10 wherein discovering status information comprises discovering a local operating system without booting to the installed local operating system and the inferred state comprises a RAID configuration.

14. The method of claim 10 wherein discovering status information comprises discovering a local operating system without booting to the installed local operating system and the inferred state comprises an image capture.

15. The method of claim 10 wherein discovering status information comprises discovering a non-running configuration agent on the target information handling system and the inferred state comprises an unmanaged target information handling system.

16. The method of claim 10 wherein discovering status information comprises discovering a running configuration agent on a target information handling system having a required but unassigned configuration and the inferred state comprises a stable wait state to wait for assignment of a configuration.

17. The method of claim 10 wherein discovering status information comprises discovering a target information handling system having an applied configuration and the inferred state comprises a stable up state.
